(19) United States
(12) Patent Application Publication
(10) Pub. No.: US 2018/0171806 A1
(43) Pub. Date: Jun. 21, 2018

(54) THREE-DIMENSIONALLY WOVEN CERAMIC MATRIX COMPOSITE TURBINE BLADE

(71) Applicants: Rolls-Royce North American Technologies, Inc., Indianapolis, IN (US); Rolls-Royce Corporation, Indianapolis, IN (US)

(72) Inventors: Ted J. Freeman, Danville, IN (US); David J. Thomas, Brownsburg, IN (US); Aaron D. Sippel, Zionsville, IN (US)

(21) Appl. No.: 15/387,136

(22) Filed: Dec. 21, 2016

(51) Int. Cl. F01D 5/28; F01D 5/30

(52) U.S. Cl. CPC F01D 5/282; F05D 2300/6033; F05D 2240/30; F01D 5/3007

(57) ABSTRACT

A ceramic matrix composite turbine blade for use in a gas turbine engine includes a root, a platform, and an airfoil. The ceramic matrix composite is formed from a three-dimensional preform and a ceramic matrix material so that the root, the platform, and the airfoil cooperate to form a one-piece monolithic turbine blade

### FIELD OF THE DISCLOSURE

The present disclosure relates generally to turbine blades for gas turbine engines, and more specifically to turbine blades comprising ceramic-containing materials.

### BACKGROUND

Gas turbine engines are used to power aircraft, watercraft, power generators, and the like. Gas turbine engines typically include a compressor, a combustor, and a turbine. The compressor compresses air drawn into the engine and delivers high-pressure air to the combustor. In the combustor, fuel is mixed with the high-pressure air and is ignited. Hot, high-pressure products of the combustion reaction in the combustor are directed into the turbine where work is extracted to drive the compressor and, sometimes, an output shaft. Leftover products of the combustion are exhausted out of the turbine and may provide thrust in some applications.

Turbine blades interact with the hot, high-pressure products of the combustor and convert them to mechanical rotation. The interaction of combustion products with the blades heats the blades. Turbine blades are often made from high-temperature compatible materials and/or are actively cooled by supplying relatively cool air to the turbine blades. To this end, some airfoils incorporate composite materials or heat inserts to withstand very high temperatures. Design and manufacture of turbine blades from composite materials presents challenges because of the geometry and strength required for the parts.

### SUMMARY

The present disclosure may comprise one or more of the following features and combinations thereof and/or features and combinations of the claims.

One embodiment of the present invention is a turbine blade made from a ceramic matrix composite material and adapted for use in a gas turbine engine In some embodiments, the turbine blade comprises an airfoil shaped to interact with hot gasses moving through a gas path of a gas turbine engine to cause rotation of the turbine blade when the turbine blade is used in the gas turbine engine, a root adapted to couple the turbine blade to a disk of the gas turbine engine, and a platform arranged to extend between and interconnect the root and the airfoil. In some embodiments, the platform is shaped to extend outwardly from the root and the airfoil to block gasses from the gas path moving toward the root when the turbine blade is used in the gas turbine engine. In some embodiments, the turbine blade includes a three-dimensional preform and a ceramic matrix material arranged together to form a one-piece turbine blade.

In some embodiments, the three-dimensional preform includes radial reinforcement fibers arranged along a first axis, axial reinforcement fibers arranged along a second axis, circumferential reinforcement fibers arranged along a third axis and the first axis is generally orthogonal to the second axis and the third axis and the second axis is generally orthogonal to the third axis. In some embodiments, at least one of the radial reinforcement fibers is arranged to extend from the root, through the platform, to the airfoil.

In some embodiments, the number of radial reinforcement fibers along the first axis is greater than the number of axial reinforcement fibers along the second axis and the number of radial reinforcement fibers is greater than the number of circumferential reinforcement fibers. In some embodiments, the root includes a stalk coupled to the platform to extend away from the platform and the airfoil and an attachment coupled to the stalk to locate the stalk between the platform and the attachment, the attachment is arranged to extend away from the platform and the stalk, and the radial reinforcement fibers extend from the platform to the attachment along the first axis.

In some embodiments, the axial reinforcement fibers in the platform are arranged along the second axis and the number of radial reinforcement fibers along the first axis is greater than the number of axial reinforcement fibers along the second axis. In some embodiments, the platform includes a platform body coupled to the airfoil and arranged to extend outwardly from the airfoil along the second and third axes, a forward rail coupled to the platform body and arranged to extend away from the airfoil toward the root, and an aft rail coupled to the platform body in spaced-apart relation to the forward rail and arranged to extend away from the airfoil toward the root.

In some embodiments, the amount of radial reinforcement fibers, axial reinforcement fibers, and circumferential reinforcement fibers are about equal in the platform. In some embodiments, the three-dimensional preform is formed of a three-dimensional weave. In some embodiments, the three-dimensional preform is formed of a three-dimensional braid.

In some embodiments, the turbine blade is formed to include a cooling cavity therein. In some embodiments, the root is formed to include an inlet aperture arranged to open into the cooling cavity and adapted to be coupled to a cooling air source to cause cooling air to be admitted through the inlet aperture to the cooling cavity, and an exit aperture formed in the airfoil and arranged to open into the cooling cavity and communicate cooling air from the cooling air source through the inlet aperture, into the cooling cavity, and out of the exit aperture.

In some embodiments, the turbine blade is formed to include a plurality of spaced-apart cooling channels adapted to be coupled to a cooling air source and configured to communicate cooling air through the cooling channels. In some embodiments, portions of the three-dimensional preform extend into each of the cooling channels to cause the cooling air passing through each of the cooling channels to swirl and induce turbulence maximizing convective heat transfer from the turbine blade to the cooling air.

In some embodiments, the airfoil is formed to include a plurality of spaced apart trailing-edge cooling channels arranged to extend from a leading edge of the airfoil toward a trailing edge of the airfoil. In some embodiments, the plurality of trailing-edge cooling channels are in fluid communication with one of the plurality of spaced-apart cooling channels.

In some embodiments, the turbine blade has a winglet coupled to and extending outwardly away from the airfoil to locate the airfoil between the winglet and the platform and configured to minimize over tip leakage of hot gasses. In some embodiments, the turbine blade has a trailing-edge insert coupled to the trailing edge of the airfoil and arranged to extend away from the leading edge and the trailing edge of the airfoil and between the winglet and the platform.

In some embodiments, a distal end of the trailing-edge insert is located between the air foil and the winglet. In some embodiments, a proximal end of the trailing-edge insert is located between the platform and the airfoil.

These and other features of the present disclosure will become more apparent from the following description of the illustrative embodiments.

### BRIEF DESCRIPTION OF THE DRAWINGS

FIG. 1 is a perspective view of a first embodiment of a turbine blade in accordance with the present disclosure showing that the turbine blade includes an airfoil, a platform, and a root and suggesting that the turbine blade is made from a three-dimensional preform and a ceramic matrix material that cooperate together to form a one-piece monolithic turbine blade;

FIG. 2 is a perspective view of a second embodiment of a turbine blade in accordance with the present disclosure showing that the turbine blade is formed to include a series of spaced apart cooling channels that extend from the airfoil through the platform to the root;

FIG. 3 is a perspective view of a third embodiment of a turbine blade in accordance with the present disclosure showing that the turbine blade further includes a winglet to minimize over tip leakage of hot gasses and a trailing-edge insert coupled to a trailing edge of the airfoil and that the turbine blade is formed to include a plurality of cooling channels and a plurality of trailing-edge cooling channels; and

FIG. 4 is a front elevation view of the turbine blade of FIG. 3 showing that a distal end of the trailing-edge insert is trapped between the airfoil and the winglet and a proximal end of the trailing-edge insert is trapped between the airfoil and the platform.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

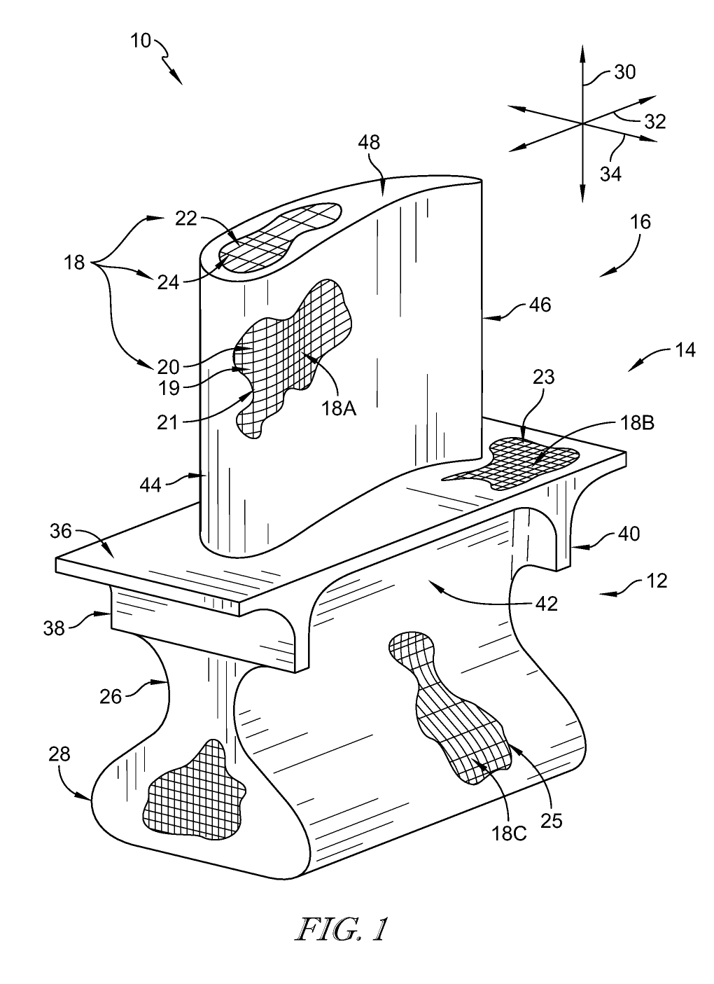

An illustrative turbine blade 10 is adapted for use in a gas turbine engine is shown in FIG. 1. The turbine blade 10 includes a root 12, a platform 14, and an airfoil 16 extending from the platform 14 as shown in FIG. 1. Illustratively, the root 12 is configured to couple the turbine blade 10 to a disk for rotation about a central axis of a gas turbine engine. The platform 14 is arranged around the airfoil 16 and is configured to define a gas path in the gas turbine engine and block gasses from moving from the gas path toward the root 12. The airfoil 16 is spaced-apart radially from the root 12 and is shaped to interact with hot gasses flowing through the gas path during operation of the gas turbine engine.

As suggested in FIG. 1, turbine blade 10 is made from a ceramic matrix composite including a three-dimensional preform 18 and a ceramic matrix material 19. Three dimensional preform 18 is made from silicon carbide fibers that are woven or braided together to form a one-piece preform. Ceramic matrix material 19 is made from a silicon carbide mixture that is infiltrated into the three-dimensional preform 18. Together, the three-dimensional preform 18 and the ceramic matrix material 19 cooperate to form a single-piece turbine blade.

The three-dimensional preform 18 includes radial reinforcement fibers 20 arranged generally along a first axis 30, axial reinforcement fibers 22 arranged generally along a second axis 32, and circumferential reinforcement fibers 24 arranged generally along a third axis 34. Radial reinforcement fibers 20, axial reinforcement fibers 22, and circumferential reinforcement fibers 24 may be woven or braided together to form three-dimensional preform 18 and combine with ceramic matrix material 19 and form the one-piece monolithic turbine blade. Some of the axial reinforcement fibers 22 may wrap around a leading edge or leading end of the turbine blade 10 to provide hoop fibers.

As shown in FIG. 1, radial reinforcement fibers 20 extend along the first axis 30 and are generally orthogonal to axial reinforcement fibers 22 and circumferential reinforcement fibers 24 along the second axis 32 and third axis 34, respectively. Axial reinforcement fibers 22 extend along the second axis 32 and are generally orthogonal to circumferential reinforcement fibers 24 along the third axis 34. Therefore, first axis 30 is generally orthogonal to second axis 32 and third axis 34 and second axis 32 is generally orthogonal to third axis 34. In some embodiments, the first axis 30 may not be orthogonal to the third axis 34 due to the curvature of turbine blade 10 around the central axis of the gas turbine engine.

Radial reinforcement fibers 20, axial reinforcement fibers 22 and circumferential reinforcement fibers 24 may not be exclusive to the first axis 30, second axis 22, and third axis 24, respectively. For example, at least one radial reinforcement fiber 20 in root 12 may extend along the first axis 30 in root 12 and transition to extend along the second axis 32 or third axis 34 in platform 14. Further, at least one radial reinforcement fiber 20 in airfoil 16 may extend along first axis 30 in airfoil 16 and transition to extend along second axis 32 or third axis 34 in platform 14. At least one radial reinforcement fiber 20 is arranged to extend from root 12, though platform 14, to airfoil 16. In this way, turbine blade 10 is formed as a one-piece monolithic turbine blade.

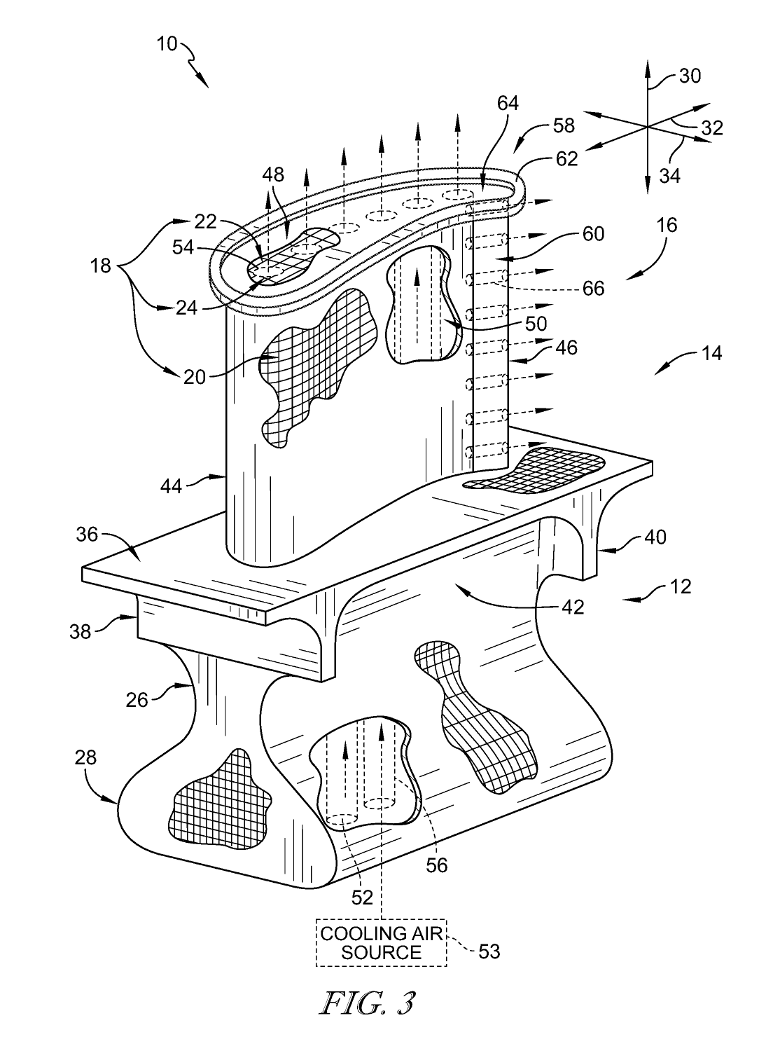

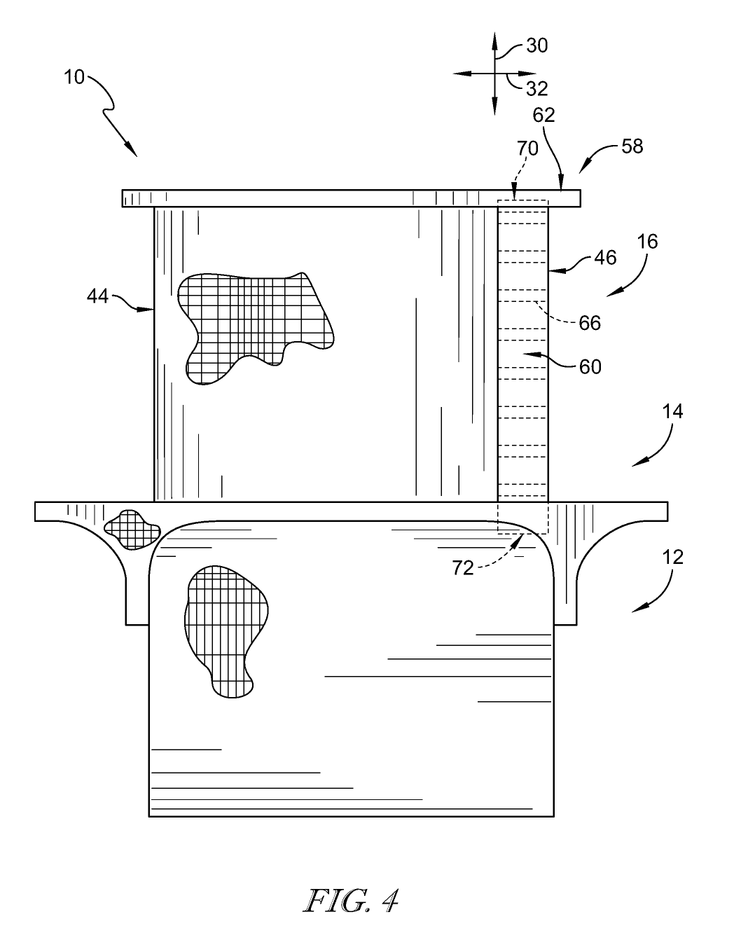

In the illustrative embodiment, the three dimensional preform 18 is processed into a ceramic matrix composite component by chemical vapor infiltration (CVI) or by melt infiltration of matrix materials. In some embodiments, the three dimensional preform 18 is co-processed with other preforms and/or components such that they are combined into a final component as suggested in FIGS. 3 and 4.

Root 12 includes a stalk 26 and an attachment 28 as shown in FIG. 1. Stalk 26 is coupled to platform 14 and extends away from platform 14 and airfoil 16 along the first axis 30. Attachment 28 is coupled to stalk 26 and extends downward from stalk 26 along the first axis 30. Attachment 28 flares outward to provide a shape suitable to attach turbine blade 10 to a disk (not shown) within the gas turbine engine. In the present embodiment, attachment 28 takes the form of a dovetail, fir-tree shapes, or any other suitable shapes. Radial reinforcement fibers 20 within root 12 extend from platform 14 to attachment 28 along the first axis 30. The number of radial reinforcement fibers 20 arranged along the first axis 30 in root 12 is greater than the number of axial reinforcement fibers 22 arranged along second axis 32 and circumferential reinforcement fibers 24 arranged along the third axis 34. Root 12 contains a biased number of radial reinforcement fibers 20 to resist forces acting on turbine blade 10 during operation of the gas turbine engine.

Platform 14 includes a platform body 36, a forward rail 38, and an aft rail 40 as shown in FIG. 1. Platform body 36 extends outward from airfoil 16 along the second axis 32 and third axis 34 and provides a boundary for the gas path to block the flow of hot gases from the gas path toward root 12. Forward rail 38 is coupled to platform body 36 and extends away from airfoil 16 toward root 12. Aft rail 40 is coupled to platform 14 in spaced-apart relation to forward rail 38 and extends away from airfoil 16 toward root 12. Forward rail 38 and aft rail 40 cooperate to form a damper pocket 42 between forward rail 38 and aft rail 40. Damper pocket 42 is defined in part by platform body 36, forward rail 38, aft rail 40, and root 12. The present embodiment further includes a second damper pocket (not shown) on the opposite side of turbine blade 10 with respect to second axis 32. In other embodiments, turbine blade 10 includes any number of damper pockets 42. In one example, the number of radial reinforcement fibers 20, axial reinforcement fibers 22, and circumferential reinforcement fibers 24 are about equal in platform 14. In another example, the numbers of axial reinforcement fibers 22 and circumferential reinforcement fibers 24 are greater than the number of radial reinforcement fibers 20 in platform 14.

Airfoil 16 includes a leading edge 44, a trailing edge 46, and a radial end 48 as shown in FIG. 1. Airfoil 16 is arranged such that leading edge 44 is spaced apart from trailing edge 46 along second axis 32. Radial end 48 is spaced apart from platform 14 and forms a distal end of airfoil 16 relative to first axis 30. Airfoil 16 is formed with a curvature that bends as airfoil 16 extends from the leading edge 44 to trailing edge 46 along second axis 32. The number of radial reinforcement fibers 20 arranged along the first axis 30 in airfoil 16 is greater than the number of axial reinforcement fibers 22 arranged along second axis 32 and circumferential reinforcement fibers 24 arranged along the third axis 34. Airfoil 16 contains a biased number of radial reinforcement fibers 20 to resist forces acting on turbine blade 10 during operation of the gas turbine engine.

In some embodiments, turbine blade 10 includes a ceramic matrix composite airfoil 21, a ceramic matrix composite platform 23, and a ceramic matrix composite root 25 as shown in FIG. 1. Ceramic matrix composite airfoil 21 provides a portion of three-dimensional preform 18 in airfoil 16. Ceramic matrix composite platform 23 forms a portion of three-dimensional preform 18 in platform 14. Ceramic matrix composite root 25 forms a portion of three-dimensional preform 18 in root 12. Together, ceramic matrix composite airfoil 21, ceramic matrix composite platform 23, and root matrix 25 combine to form turbine blade 10 as the one-piece monolithic turbine blade.

Ceramic matrix composite airfoil 21 includes ceramic matrix material and reinforcement fibers 18A that are woven or braided together to form airfoil 16 as shown in FIG. 1. In this way, reinforcement fibers 18B may extend along first axis 30, second axis 32, third axis 34, or along any axis between first axis 30, second axis 32, and third axis 34 to form airfoil 16. In a non-limiting example, reinforcement fibers 18A extending through airfoil 16 along second axis 32 may transition to extend along the third axis to form leading edge 44 as shown in FIG. 1. Ceramic matrix composite airfoil 21 is formed with a greater number of reinforcement fibers 18A in the radial direction along first axis 30 to resist loads acting on turbine blade 10 during operation of the gas turbine engine.

Ceramic matrix composite platform 23 includes ceramic matrix material and reinforcement fibers 18B that are woven or braided together to form platform 14 as shown in FIG. 1. In this way, reinforcement fibers 18B may extend along first axis 30, second axis 32, third axis 34, or along any axis between first axis 30, second axis 32, and third axis 34 to form platform 14. In a non-limiting example, reinforcement fibers 18B extending through platform 14 along second axis 32 may transition to extend along first axis 30 to form platform body 36 as shown in FIG. 1.

Ceramic matrix composite root 25 includes ceramic matrix material and reinforcement fibers 18C that are woven or braided together to form root 12 as shown in FIG. 1. In this way, reinforcement fibers 18C may extend along first axis 30, second axis 32, third axis 34, or along any axis between first axis 30, second axis 32, and third axis 34 to form root 12. In a non-limiting example, reinforcement fibers 18C extending through root 12 along first axis 30 may transition to extend along an axis between first axis 30 and third axis 34 to form attachment 28 as shown in FIG. 1. Ceramic matrix composite root 25 is formed with a greater number of reinforcement fibers 18A in the radial direction along first axis 30 to resist loads acting on turbine blade 10 during operation of the gas turbine engine.

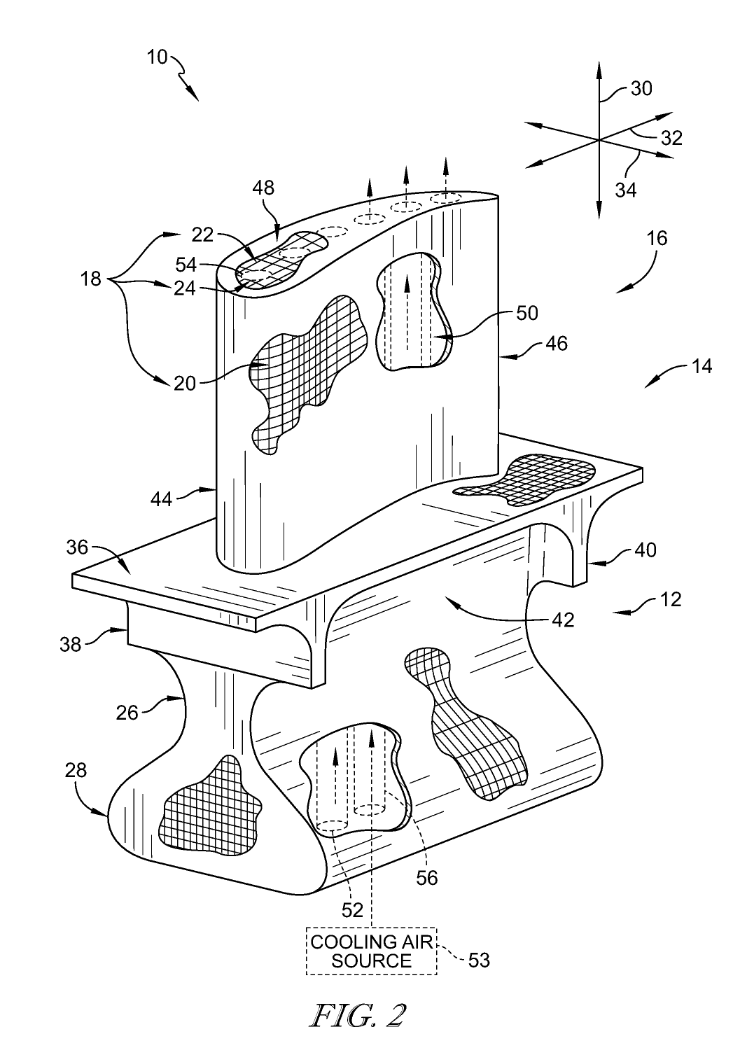

In another embodiment, turbine blade 10 is formed to include at least one cooling cavity 50. Cooling cavity 50 is arranged to extend from root 12, through platform 14, to airfoil 16 to communicate cooling air through turbine blade 10 so that turbine blade 10 is cooled as shown in FIG. 2. Cooling cavity 50 may be formed during the three-dimensional preforming process, by machining turbine blade 10, or by using a mandrel (not shown) during the three-dimensional preforming process. Cooling cavity 50 may be formed during the three-dimensional preforming process by selectively arranging the three-dimensional preform reinforcing fibers 20, 22, 24 to form cooling cavity 50. Machining turbine blade 10 includes the steps of forming turbine blade 10 with three dimensional preform 18 and ceramic matrix material 19 and drilling through turbine blade 10 to form cooling cavity 50. The mandrel may take the form of a metal or carbon tool or rod and can be removed through oxidation to reveal cooling cavity 50.

Portions of three-dimensional preform 18 are arranged to extend into cooling cavity 50 to cause the cooling air to swirl and induce turbulence maximizing convective heat transfer from turbine blade 10 to the cooling air as suggested in FIG. 2. In some embodiments, the portions of three-dimensional preform 18 that cause the cooling air to swirl and induce turbulence are radial reinforcement fibers 20, axial reinforcement fibers 22, and circumferential reinforcement fibers 24. In other embodiments, the portions of three-dimensional preform 18 that cause the cooling air to swirl and induce turbulence are added during the formation of cooling cavity 50.

Root 12 is formed to include an inlet aperture 52 arranged to open into cooling cavity 50 and adapted to be coupled to a cooling air source 53 to cause cooling air to be admitted through inlet aperture 52 to the cooling cavity 50 as shown in FIG. 2. In one embodiment, inlet aperture 52 is a single inlet aperture formed in root 12. In another embodiment, inlet aperture 52 is a plurality of inlet apertures 52 formed in root 12.

Airfoil 16 is further formed to include an exit aperture 54 arranged to open into the cooling cavity and communicate cooling air from cooling air source 53 through inlet aperture 52, into cooling cavity 50, and out of exit aperture 54 as shown in FIG. 2. In one embodiment, exit aperture 54 is a single exit aperture formed in airfoil 16. In another embodiment, exit aperture 54 is a plurality of exit apertures 54 formed in airfoil 16.

Turbine blade 10 is formed to include a cooling channel 56 adapted to be coupled to a cooling air source and configured to communicate cooling air through turbine blade 10 as shown in FIG. 2. In one embodiment, cooling channel 56 is a single cooling channel in communication with inlet aperture 52 and exit aperture 54. In another embodiment, turbine blade 10 is formed to include a plurality of spaced-apart cooling channels 56 adapted to be coupled to cooling air source 53 and configured to communicate cooling air through turbine blade 10.

In one example, cooling channel 56 has a circular cross section as shown in FIG. 2; however, other suitable cross sections may be used. Portions of three-dimensional preform 18 extend into cooling channel 56 to cause the cooling air passing through cooling channel 56 to swirl and induce turbulence thereby maximizing convective heat transfer from turbine blade 10 to the cooling air.

In one embodiment, airfoil 16 is formed to include a plurality of spaced apart trailing-edge cooling channels 66 arranged to extend from trailing edge 46 toward leading edge 44 of the airfoil 16 as shown in FIGS. 2 and 3. Trailing-edge cooling channels 66 are in fluid communication with at least one cooling channel 56 to provide cooling air from cooling source 53, through cooling channel 56 and into trailing-edge cooling channels 66.

Airfoil 16 further includes a winglet 58 as shown in FIG. 3. Winglet 58 is coupled to airfoil 16 to locate airfoil 16 between winglet 58 and platform 14 and configured to minimize over tip leakage of hot gasses. In some embodiments, winglet 58 is coupled to radial end 48 of airfoil 16. Winglet 58 is arranged to extend outwardly away from airfoil 16.

In one embodiment, winglet 58 extends away from airfoil 16 along second axis 32 and third axis 34 as shown in FIG. 3. In another embodiment, winglet 58 extends away from airfoil 16 along first axis 30, second axis 32, and third axis 34 to form a raised edge 62 circumscribing and extending away from radial edge 48 of airfoil 16. Winglet 58 is formed to include a recessed region 64 formed by raised edge 62 and radial end 48 of airfoil 16. Cooling cavity 50 communicates cooling air from cooling source 53, into inlet aperture 52, through cooling channel 56, out of exit aperture 54 and into recessed region 64.

Illustratively, radial-reinforcement fibers 20 extend from airfoil 16 along the first axis 30 and form winglet 58 by transitioning and extending along the second and third axes 32, 34. In some embodiments, winglet 58 is formed from radial reinforcement fibers 20, axial reinforcement fibers 22, and circumferential reinforcement fibers 24 during the manufacturing of three-dimensional preform 18 so that winglet 58 is a part of the one-piece monolithic turbine blade.

Airfoil 16 further includes a trailing-edge insert 60 as shown in FIG. 3. Trailing-edge insert 60 is coupled to trailing edge 46 of airfoil 16 and extends away from leading edge 44 and trailing edge 46 along second axis 32. Trailing-edge insert 60 is arranged to extend between winglet 58 and platform 14 as shown in FIGS. 3 and 4.

Trailing-edge insert 60 includes a distal-insert end 70 and a proximal-insert end 72 as shown in FIG. 4. Distal-insert end 70 extends from airfoil 16 into winglet 58 along the first axis 30. Distal-insert end 70 is located between airfoil 16 and winglet 58. In one embodiment, proximal-insert end 72 extends from airfoil 16 into platform 14 and is located between platform 14 and airfoil 16. In another embodiment, proximal-insert end 72 extends from airfoil 16 into platform 14 and into root 12 and is located between root 12 and platform 14.

Trailing-edge insert 60 is illustratively made from a monolithic ceramic body. In other embodiments, trailing-edge insert 60 may be metallic. The trailing-edge insert 60 may be formed to include cooling apertures 66 as shown in FIGS. 3 and 4.

In some embodiments, the trailing-edge insert 60 may be made from another ceramic matrix composite preform that is co-processed with the rest of the turbine blade 10. In some such embodiments, the trailing-edge insert 60 may include a woven fiber preform. In other such embodiments, the trailing edge insert 60 may include two dimensional, uni-directional, and/or random fibers. Fibers of the trailing-edge insert may be biased with more radially extending fibers than other directional fibers. The bias may be less than the three-dimensional preform 18.

The trailing-edge insert 60, whether monolithic or composite, may be co-processed with the three-dimensional preform 18. Accordingly, the turbine blade 10 may be an integrated, single-piece component at the end of manufacturing.

In some embodiments, a 3D woven/braided (here after referred to as 3D preforming) CMC airfoil that could take the form of a turbine blade or vane. The 3D reinforcement discussed herein could either have the fibers in the third direction travelling fully through the part from one face to the other, thus effectively tying all the layers together; or only partially through the thickness, tying adjacent layers to each other such as in an angle interlock pattern.

In some embodiments, the turbine blade could be an integrally formed, uncooled blade containing an airfoil, platform, stalk and attachment. In some embodiments, the platform would take the form of the inner flow path member, would protrude circumferential out from the airfoil, would be positioned between the airfoil and stalk and may contain sealing features including, but not limited to, forward and aft rails and seal or damper pockets. In some embodiments, below the platform, a vertical section (stalk or shank) would be used to transition from the airfoil shape to the shape at the top of the attachment. In some embodiments, the attachment is envisioned as a single lobed dovetail attachment with flank angle between 45 and 75 degrees. In some embodiments, it is possible for the flank angle to be lower or higher.

In some embodiments, the 3D preforming that may allow the airfoil to be fabricated as a single piece preform that could be placed into tooling for fiber coating, if required, and densification without the need for additional assembly as is the case with standard 2D lay-ups. In 3D preforming, a loom or braider capable of controlling the amount of and position of fiber in three axes may be used. Fibers may be added or dropped out of the preform via a control program in order to form the basis of the desired shape.

In some embodiments, the amount of fiber can be controlled in each of the three directions. This could allow the material properties to be tailored throughout the airfoil. As an example, a high fraction of radial fibers is desired in the airfoil while a more balanced fiber distribution, or even a high circumferential fraction, may be desired in the platform.

In some embodiments, uncooled blades include the addition of a tip shroud or winglet. This embodiment could be used either with or without a platform and has the advantage of reducing the effects of vibration on the airfoil. This may be useful with high aspect ratio airfoils. The ability to include a tip shroud or winglet feature can also lead to improved engine efficiencies by reducing over tip leakage.

In some embodiments, the 3D preform may be fabricated with a hollow cavity. This could be done as part of the preforming process or by using a mandrel that is preformed over. If a mandrel is used, it would be removed to produce the desired hollow cavity.

In some embodiments, depending on the fabrication procedures adopted, the mandrel may be removed either part way thru the preforming process, at the end of preforming, or after rigidization. By including a hollow cavity in the airfoil, cooling air could be introduced into the airfoil to allow operation at even higher temperatures.

In some embodiments, a woven or braided CMC may have an inside surface of the cavity that would be rough and could act as turbulators or features that would increase the transfer of heat from the airfoil to the cooling air by either increasing the convective heat transfer coefficient or simply by increasing overall internal surface area. Air may exit the blade via tip ejection or by film cooling holes that are formed or machined into the surface of the airfoil. It is also envisioned that an impingement tube could be inserted into the airfoil to further increase the heat transfer coefficient on the inner surface of the airfoil but also to appropriately distribute the cooling air within the inner cavity of the airfoil.

In some embodiments, the attachment portion of the airfoil may be desired to be axial to minimize localized stresses. However, it is possible to angle the attachment relative to the axis of the engine to better transmit the stresses from the airfoil to the attachment, or to aid in the manufacturability of the part. This could take the form of a broach angle and could be included with any of the aforementioned embodiments.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine blade made from a ceramic matrix composite material and adapted for use in a gas turbine engine, the turbine blade comprising
an airfoil shaped to interact with hot gasses moving through a gas path of the gas turbine engine to cause rotation of the turbine blade when the turbine blade is used in the gas turbine engine,
a root adapted to couple the turbine blade to a disk of the gas turbine engine, and
a platform arranged to extend between and interconnect the root and the airfoil, the platform shaped to extend outwardly from the root and the airfoil to block gasses from the gas path moving toward the root when the turbine blade is used in the gas turbine engine,
wherein the turbine blade includes a three-dimensional preform and a ceramic matrix material arranged together to form a one-piece turbine blade.

2. The turbine blade of claim 1, wherein the three-dimensional preform includes radial reinforcement fibers arranged along a first axis, axial reinforcement fibers arranged along a second axis, circumferential reinforcement fibers arranged along a third axis and the first axis is generally orthogonal to the second axis and the third axis and the second axis is generally orthogonal to the third axis.

3. The turbine blade of claim 2, wherein at least one of the radial reinforcement fibers is arranged to extend from the root, through the platform, to the airfoil.

4. The turbine blade of claim 3, wherein a number of radial reinforcement fibers along the first axis is greater than a number of axial reinforcement fibers along the second axis and a number of radial reinforcement fibers is greater than a number of circumferential reinforcement fibers.

5. The turbine blade of claim 2, wherein the root includes a stalk coupled to the platform to extend away from the platform and the airfoil and an attachment coupled to the stalk to locate the stalk between the platform and the attachment, the attachment is arranged to extend away from the platform and the stalk, and the radial reinforcement fibers extend from the platform to the attachment along a first axis.

6. The turbine blade of claim 5, wherein axial reinforcement fibers in the platform are arranged along the second axis and a number of radial reinforcement fibers along the first axis is greater than a number of axial reinforcement fibers along the second axis.

7. The turbine blade of claim 2, wherein the platform includes a platform body coupled to the airfoil and arranged to extend outwardly from the airfoil along the second and third axes, a forward rail coupled to the platform body and arranged to extend away from the airfoil toward the root, and an aft rail coupled to the platform body in spaced-apart relation to the forward rail and arranged to extend away from the airfoil toward the root.

8. The turbine blade of claim 7, wherein the number of radial reinforcement fibers in the platform is less than the number of fibers in any other single direction.

9. The turbine blade of claim 1, wherein the three-dimensional preform is formed of a three-dimensional weave.

10. The turbine blade of claim 1, wherein the three-dimensional preform is formed of a three-dimensional braid.

11. The turbine blade of claim 1, wherein the turbine blade is formed to include a cooling cavity therein.

12. The turbine blade of claim 11, wherein the root is formed to include an inlet aperture arranged to open into the cooling cavity and adapted to be coupled to a cooling air source to cause cooling air to be admitted through the inlet aperture to the cooling cavity and the airfoil is formed to include an exit aperture arranged to open into the cooling cavity and communicate cooling air from the cooling air source through the inlet aperture, into the cooling cavity, and out of the exit aperture.

13. The turbine blade of claim 1, wherein the turbine blade is formed to include a plurality of spaced-apart cooling channels adapted to be coupled to a cooling air source and configured to communicate cooling air through cooling channels.

14. The turbine blade of claim 13, wherein portions of the three-dimensional preform extend into each of the spaced-apart cooling channels to cause the cooling air passing through each of the spaced-apart cooling channels to swirl and induce turbulence maximizing convective heat transfer from the turbine blade to the cooling air.

15. The turbine blade of claim 14, wherein the airfoil is formed to include a plurality of spaced apart trailing-edge cooling channels arranged to extend from a trailing edge of the airfoil toward a leading edge of the airfoil.

16. The turbine blade of claim 15, wherein the plurality of trailing-edge cooling channels are in fluid communication with one of the plurality of spaced-apart cooling channels.

17. The turbine blade of claim 1, further comprising a winglet coupled to and extending outwardly away from the airfoil to locate the airfoil between the winglet and the platform and configured to minimize over tip leakage of hot gasses.

18. The turbine blade of claim 17, further comprising a trailing-edge insert coupled to a trailing edge of the airfoil and arranged to extend away from a leading edge and the trailing edge of the airfoil and between the winglet and the platform.

19. The turbine blade of claim 18, wherein a distal end of the trailing-edge insert is located between the airfoil and the winglet.

20. The turbine blade of claim 19, wherein a proximal end of the trailing-edge insert is located between the platform and the airfoil.
